(19) United States
(12) Patent Application Publication
(10) Pub. No.: US 2006/0220367 A1
(43) Pub. Date: Oct. 5, 2006

(54) Load suspension device comprising a contactless detector unit

(76) Inventors: Ulrich Demuth, Erbach (DE); Stefan Stross, Dielheim (DE); Son Do, Sandhausen (DE); Marco Wolf, Hochstadt (DE)

Correspondence Address: BARLEY SNYDER, LLC, 1000 WESTLAKES DRIVE, SUITE 275, BERWYN, PA, 19312, US

(21) Appl. No.: 11/278,049

(22) Filed: Mar. 30, 2006

(30) Foreign Application Priority Data
Mar. 31, 2005 (DE) 102005014792.5

(51) Int. Cl. B62D 21/11

(52) U.S. Cl. 280/788

(57) ABSTRACT

The present invention relates to a contactless detector unit for a load suspension device, which may be used, for example, for recognizing passengers in a motor vehicle, and to a corresponding load suspension device. In order to provide a detector unit for a load suspension device that, on the one hand, may be optimally calibrated and thus provides improved precision and, on the other hand, may be produced particularly cost-effectively, the overall structure being particularly stable and robust, the detector unit comprises a sensor for producing a sensor signal in response to a geometrical position of an indicator with respect to the sensor. The sensor is assembled in an assembly unit, and the position of the indicator may be changed by an actuating unit in response to a load. According to the invention, the indicator is arranged on the assembly unit, and the assembly unit comprises a flexible region, which may be moved for changing the geometrical position of the indicator with respect to the sensor.

### FIELD OF THE INVENTION

The present invention relates to a contactless detector unit for a load suspension device and to a corresponding load suspension device. The present invention relates, in particular, to load suspension devices of the type that may be used for recognizing passengers in a motor vehicle.

### BACKGROUND

In relation to airbag systems in motor vehicles, passenger recognition devices that recognize a passenger occupying a seat on the basis of his weight are frequently used to control the airbag. As a function of the recognized weight, an airbag control system may, for example, inactivate the triggering of the airbag, or it may be check whether a passenger is wearing his seat belt in accordance with the legal requirements.

Passenger recognition devices of this type require load suspension devices, which deliver corresponding electrical output signals as a function of the weight acting on the seat. Both strain gauges and various pressure sensors may be used for this purpose.

A contactless detector unit for a load suspension device of this type generally comprises a sensor for producing a sensor signal in response to a geometrical position of an indicator with respect to the sensor, the sensor signal being produced without mechanical contact between the sensor and indicator. Sensors such as Hall effect sensors and also inductive or capacitive proximity switches may be used for detection.

Load suspension devices of this type for a safety-relevant feature, such as the airbag control have problems in that known detector units for a these devices are either insufficiently accurate or else are too expensive to produce.

### SUMMARY

An object of the present invention is therefore to provide a detector unit for a load suspension device that, on the one hand, may be optimally calibrated and thus provides improved precision and, on the other hand, may be produced particularly cost-effectively. Furthermore, the overall structure should be particularly stable and robust under the harsh environmental conditions during operation of a motor vehicle.

The present invention is based on the idea that, in the case of a contactless detector unit for a load suspension device, which unit comprises a sensor for producing a sensor signal in response to a position of an indicator with respect to the sensor, the sensor and the indicator are arranged on a single assembly unit, and the assembly unit comprises a flexible region, which is movable or deformable for changing the position of the indicator with respect to the sensor.

### BRIEF DESCRIPTION OF THE DRAWINGS

The invention will be described below in greater detail with reference to the configurations illustrated in the accompanying drawings. Similar or corresponding details are provided in the figures with identical reference numerals. In the drawings:

FIG. 1 is a perspective, exploded view of a load suspension device according to a first embodiment;

FIG. 2 is a cross-sectional view taken through the load suspension device of FIG. 1;

FIG. 3 is a perspective view of a detector unit according to the first embodiment in the final assembled state;

FIG. 4 is a perspective view of the detector unit from FIG. 3 during the pre-assembly process;

FIG. 5 is a perspective view of a load suspension device according to a second embodiment during the installation of the electrical connections;

FIG. 6 is a perspective view of the arrangement from FIG. 4 in the assembled state;

FIG. 7 is a perspective view of a detector unit according to a third embodiment;

FIG. 8 is a rotated perspective view of the detector unit from FIG. 7;

FIG. 9 is a cross-sectional view through the detector unit of FIG. 8 taken along the sectional line A-A from FIG. 11;

FIG. 10 is a side view of the detector unit from FIG. 8; and

FIG. 11 is a plan view of the detector unit of FIG. 8.

### DETAILED DESCRIPTION OF THE EMBODIMENTS

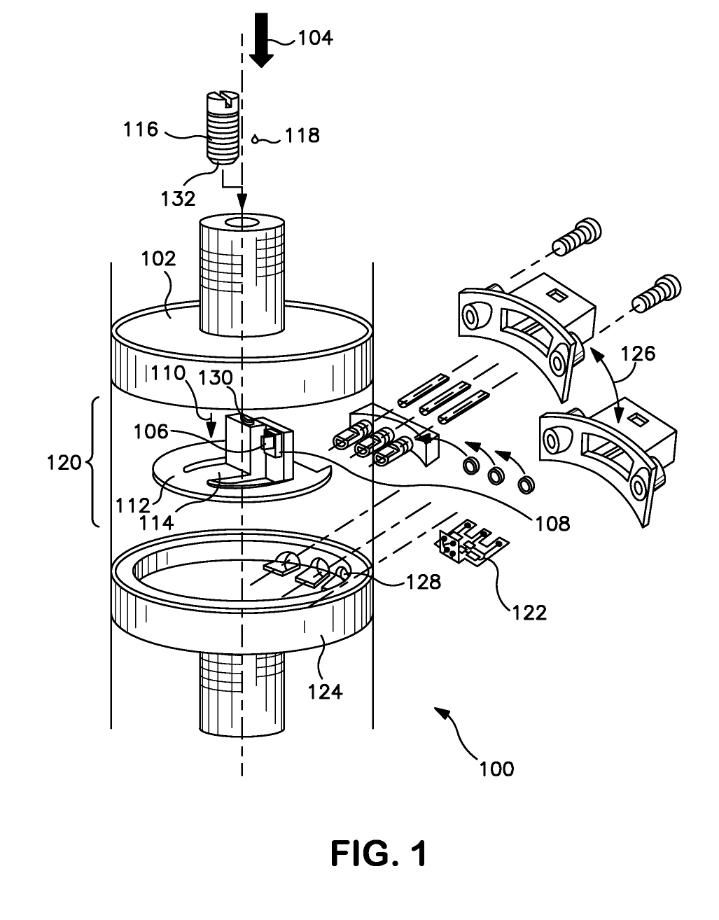

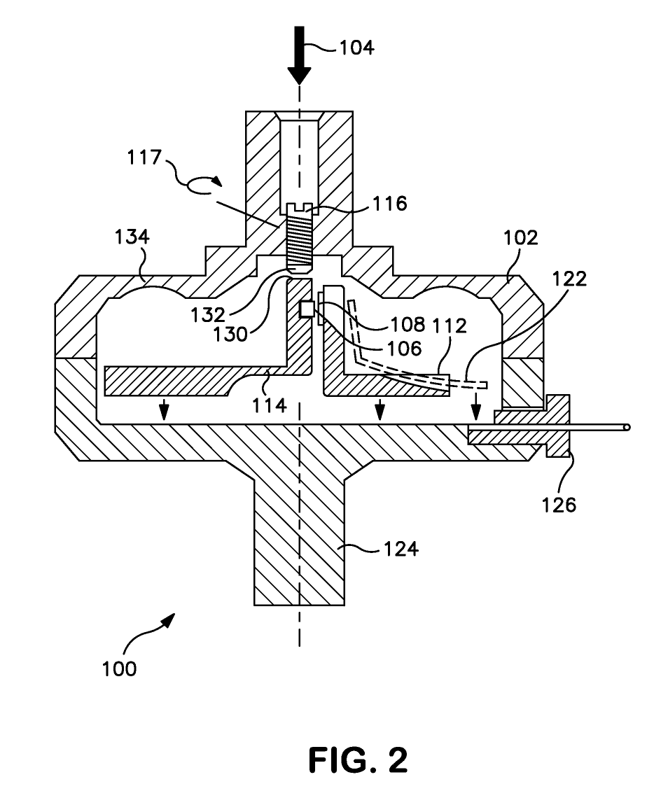

FIG. 1 is a perspective, exploded illustration of a first embodiment of a load suspension device 100 according to the present invention. The load suspension device 100 operates on the principle that a force is exerted onto the actuating unit 102 by a load in direction 104. The actuating unit 102 is thus deformed, as may be seen in conjunction with FIG. 2, and an indicator 106 is displaced, with respect to a sensor 108, in direction 1 10. In the illustrated embodiment, the indicator 106 is a permanent magnet, the magnetic field of which is detected by the sensor 108 which in this case is a Hall effect sensor.

According to the invention, the sensor 108 and the indicator 106 are assembled on an assembly unit 112. This assembly unit 112 comprises a flexible region 114, which may be formed as a film hinge and which allows the sensor 108 and the indicator 106 to be constructed on an integral part, the indicator 106 nevertheless being movable with respect to the sensor 108. In the illustrated embodiment, the indicator 106 is attached, for example using a flexible film hinge, to a cantilever beam, which is clamped on one side.

As may also be seen from FIG. 2, a set screw 116, which is provided on the actuating unit 102 as an adjusting screw, is used to calibrate the position of the indicator 106 with respect to the sensor 108 in the unloaded state of the arrangement. If a drop of adhesive 118 is added to the thread of the set screw 116, the calibrated position may reliably be maintained once the adhesive has cured.

In addition to the assembly unit 112, the detector unit 120 also comprises a flexible circuit 122 for electrically contacting the sensor 108.

In the illustrated embodiment, the actuating unit 102 forms, together with a mount 124, a substantially closed housing for the load suspension device 100. The electrical connections of the flexible circuit 122 are connected to a corresponding connection collar, in the form of a plug connector 126, and guided outward through the mount 124 in a sealed manner via openings 128. The plug connector 126 may be adapted to the respective requirements for the electrical connection of the sensor 108.

As is also clear with reference to the subsequent figures, the set screw 116 is screwed into the actuating unit 102 in such a way that it enters into direct mechanical contact with an actuating surface 130 on the assembly unit 112. The set screw 116 thus forms the contact surface 132 and may be used to adjust the position of the indicator 106 into the zero position in the unloaded state.

FIG. 2 is a cross-section through the load suspension device shown in FIG. 1. The assembly unit 112 is inserted into the mount 124 in direction 110. The mount 124, which is made, for example, from metal, and the actuating element 102, which may also be made from metal, forms a robust and protective housing for the load suspension device 100. A deformable region 134 of reduced thickness, which, when force is exerted in direction 104, allows the contact surface 132 of the set screw 116 to engage the actuating surface 130 of the assembly unit 112, is attached along the perimeter of the actuating unit 102.

The sensor 108 and the indicator 106 are both held in the assembly unit 112, the flexible region 114 allowing deflection of the indicator 106 with respect to the sensor 108 when force is exerted onto the load suspension device 100 in direction 104. For compensation of assembly air and tolerances, the zero position of the indicator 106 with respect to the sensor 108 may, according to the invention, be calibrated via the adjusting screw 116. This takes place, once the sensor 108 has been connected to the plug connector 126 using the flexible circuit 122, so the output signal of the sensor 108, in this case a Hall effect sensor, may be evaluated for the calibration process.

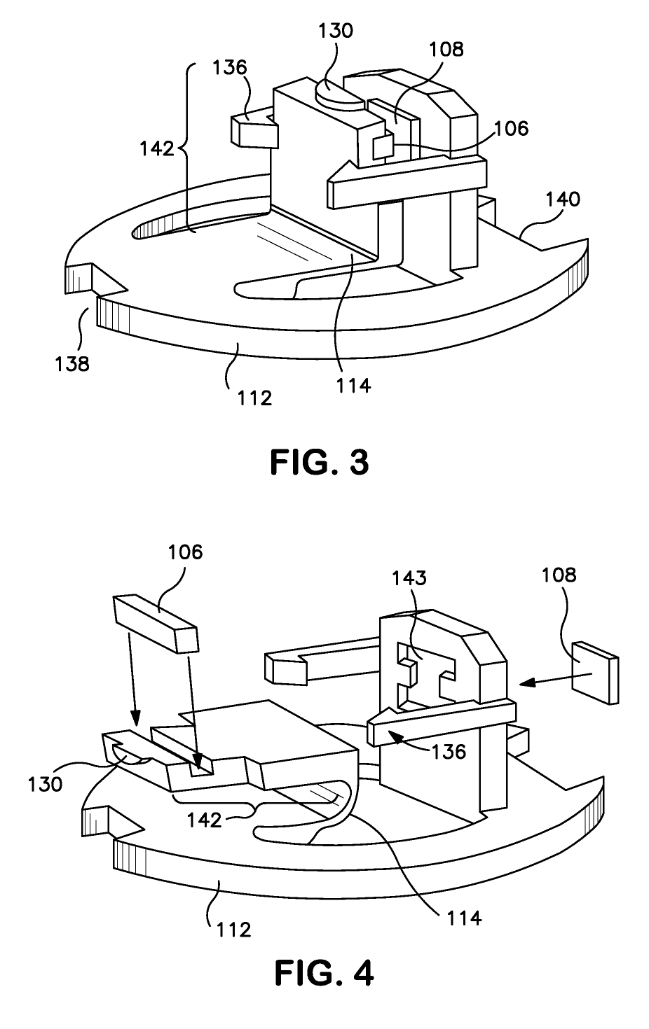

FIG. 3 is a perspective illustration of the assembly unit 112 according to a further advantageous embodiment. According to the invention, the sensor 108 and the indicator 106 are both located on the assembly unit 112. The indicator 106 is mounted such that it may move, by means of the flexible region 114, with respect to the sensor 108. When compressive force is exerted onto the actuating surface 130 in direction 104, the indicator 106 also moves in direction 104, and a corresponding sensor signal is produced by the sensor 108. If the compressive force in direction 104 then decreases again, the resilience of the flexible region 114 causes the indicator 116 to return to the zero position with respect to the sensor 108. Locking latches 136 are provided on the assembly unit 112 for guiding the indicator 106. A coded cavity 138 ensures correct positioning of the assembly unit 112 in the mount 124 during the assembly process. The recess 140 allows installation of the plug connector 126 (not shown).

FIG. 4 shows the arrangement of FIG. 3 during the assembly process of the indicator 106, in this case a permanent magnet, and the sensor 118. For the assembly of these two elements, the indicator region 142 of the assembly unit 112, in which region the magnet 106 is to be fitted, may, according to the illustrated embodiment, be bent back by substantially 20°, so the magnet 106 may be inserted in direction 104 and may, for example, be secured to the assembly unit 112 by adhesion. The flexible region 114 is sufficiently resilient for this purpose if, for example, it is in the form of a flexible film hinge.

The sensor 108 is inserted from behind through a window 143. Alternatively, the trailing end of the sensor 108 may be glued to the sensor region 146 of the assembly unit 112.

Once the magnet has been fitted, the indicator region 142 of the assembly unit 112 may be folded back into the rest position, shown in FIG. 3, and secured in this position via the locking latches 136.

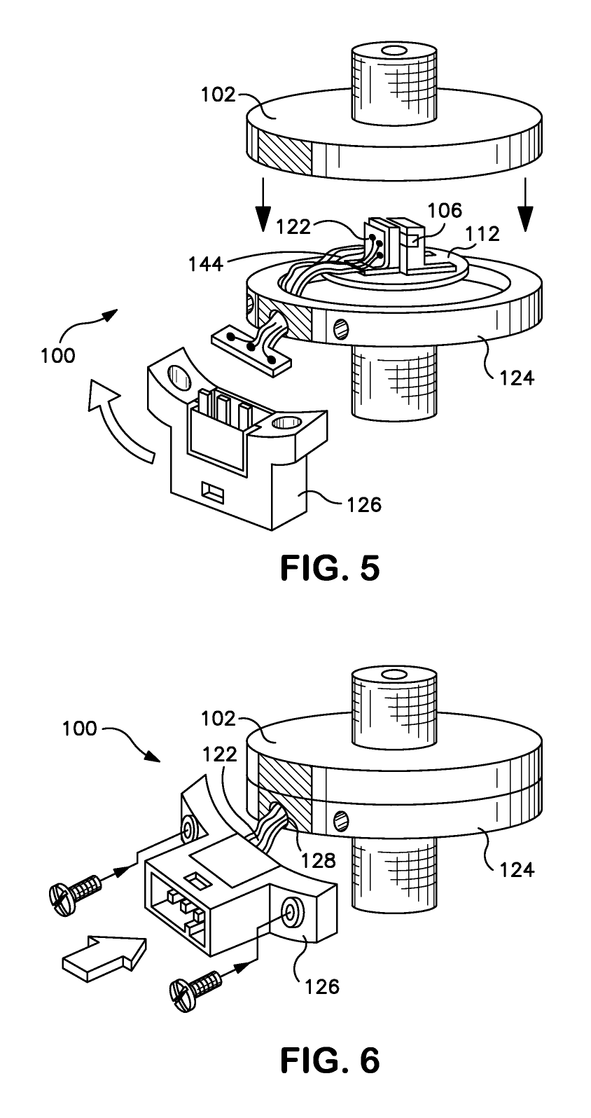

The integration and the electrical contacting of the load suspension device 100 according to a further advantageous embodiment will be described below in greater detail with reference to FIGS. 5 and 6.

Firstly, the sensor 108 and the permanent magnet 106 are assembled on the assembly unit 112 as described above. The sensor 108 is electrically contacted using a flexible circuit 122 and the conductor tracks embedded therein. A strain relief 144 prevents the flexible circuit 122 from becoming accidentally detached from the sensor 108. In the illustrated embodiment, the flexible circuit 122 is guided outward through an opening 128 in the mount 124 and is only contacted with the plug connector 126 outside.

In all of the foregoing embodiments, the indicator region 142, to which the indicator 106 is fixed, is mechanically connected to the rest of the assembly unit 112, via the flexible region 114, on only one side. In other words, in the event of deflection caused by the exertion of forces, the indicator 106 moves substantially on a circular path, the centre of which is defined by the flexible region 114. In the event of marked deflections caused by compressive force exerted in direction 104, non-linearities, which may have an adverse effect on the characteristic of the load suspension device 100, may thus occur. Moreover, the production of an assembly unit 112 according to the embodiments illustrated in FIGS. 1 to 6 is comparatively expensive.

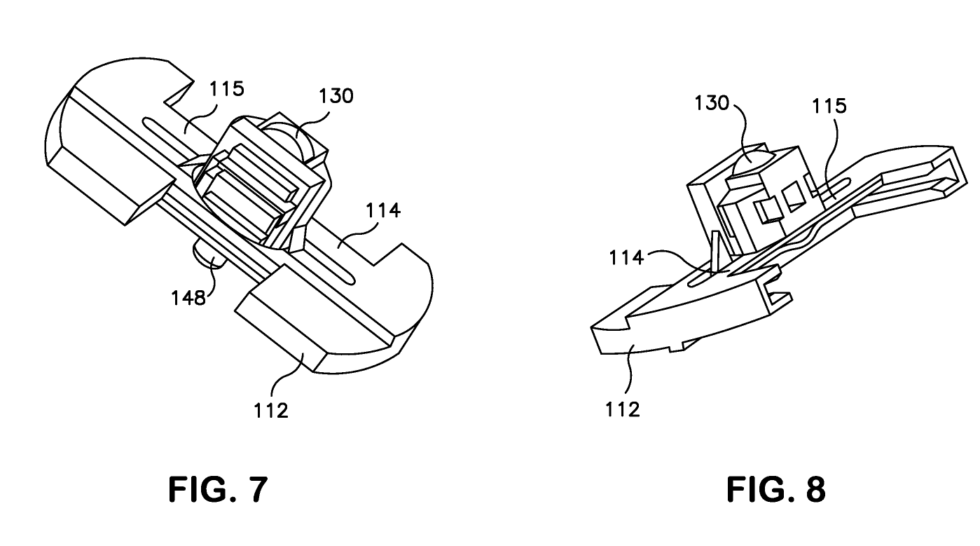

The alternative embodiment, described below with reference to FIGS. 7 to 11, is able to overcome these drawbacks. In this case, the indicator region 142, in which the indicator 106 is assembled, is connected to the rest of the assembly unit 112 via flexible regions 114, 115 formed as resilient webs each being cut free and fixed on two sides. The exertion of force in direction 104 causes the flexible regions 114, 115 to stretch, and the indicator 106 is deflected precisely parallel to the direction in which force is exerted. The illustrated construction may also be produced more easily.

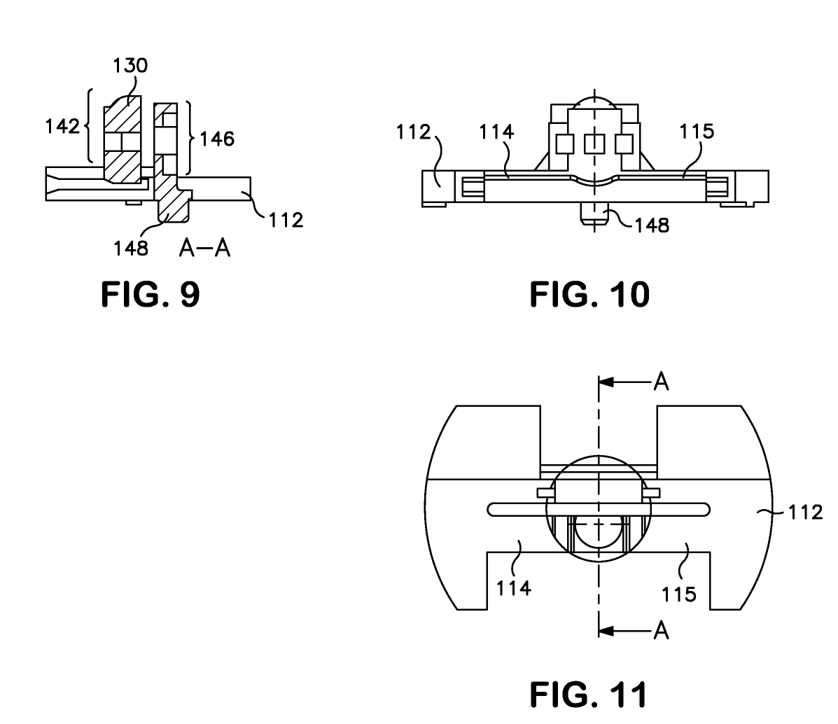

Both the sensor 108 and the indicator 106 are assembled, as may be seen from FIG. 9, from behind, through corresponding openings in the indicator region 142 and the corresponding sensor region 146. Moreover, as may be seen from FIG. 9, the sensor region is in direct mechanical contact, via a corresponding projection 148, with the mount 124 and thus allows maximum stability of the position of the sensor 108.

The load suspension device 100 according to the invention thus allows a seat load sensor, for example, which is precisely adjustable and operable in a robust and reliable manner even under mechanical and thermal stresses, to be produced in a simple manner. However, the principles according to the invention may, of course, also be used for a broad range of other applications in which load suspension devices are required.

The sensor 108 and indicator 106 may thus be assembled in a particularly simple manner, a minimal number of individual parts being provided. The solution according to the invention also has the advantage that the indicator 106 and sensor 108 are held in vibration resistant and secure manner, even under high mechanical and thermal stresses.

According to an advantageous development of the present invention, the indicator 106 is held in an indicator region of the assembly unit 112 in such a way that its position with respect to the sensor 108 is adjustable in an unloaded state. The required calibration process may thus be carried out in a zero position.

This calibration process may be carried out in a particularly neat manner in that the position of the indicator 106 may be changed by an actuating unit 102, and the actuating unit 102 comprises a contact region for moving the indicator 106, the position of which may be adjusted for adjusting the indicator 106 with respect to the sensor 108 in the unloaded state. The contact region may, for example, be formed by an adjusting screw, for example a set screw 116, which is screwed in to the extent that, in the unloaded state, the indicator 106 assumes a defined zero position with respect to the sensor. A screw of this type does not require any expensive tools and is an inexpensive standard assembly element. In order to prevent the position of the screw from changing accidentally during operation, it may also be secured using an adhesive 118.

According to an advantageous embodiment of the present invention, the flexible region 114 of the assembly unit 112 is formed by a film hinge, so the indicator 106 is pivotally mounted on a portion, fixed only on one side, of the assembly unit 112. This arrangement has the advantage that only minor forces oppose deflection by the actuating unit 102, thus allowing the sensor 108 to respond more easily to an exerted load. Moreover, comparatively large deflections are possible. For the assembly of the indicator 106, this embodiment has the further advantage that the indicator region, in which the indicator is to be assembled, may be swiveled sufficiently far during the assembly process that optimal accessibility for automated fitting of the indicator 106 is ensured.

In order, in this case, to secure the region in which the indicator 106 is assembled with respect to the sensor 108, at least in a three-dimensional direction, a locking means may, according to an advantageous development, be provided.

Alternatively, the flexible region 114 may be formed by at least one resilient web, which is cut free and fixed on two sides. This embodiment has advantages, firstly, in terms of precision, since if the web is fixed on two sides, the deflection of the indicator 106 takes place precisely parallel to the force exerted by the load. This variation is also easier to implement in terms of the production process and provides improved stability with respect to mechanical stresses during operation of the motor vehicle. The resilient characteristics of the web also ensure that the indicator 106 always returns to its zero position in the unloaded state.

According to an advantageous embodiment of the present invention, the sensor 108 is a Hall effect sensor, and the indicator 106 comprises a permanent magnet. In addition to the conventional advantages of contactless measuring devices, such as the absence of wear, the use of a Hall effect sensor comprising at least one permanent magnet has the further advantage of high measurement precision and reliable detection, which is substantially independent of corrosion and other disturbing factors, of the position of the indicator. A Hall effect sensor responds with a very high degree of sensitivity to changes in the magnetic flux, so even small movements of the indicator 106 may be detected. The characteristic of a Hall effect sensor, i.e. the dependence of the sensor signal on the position of the indicator 106 and thus on the position of the actuating unit 102, may easily be adapted, by adapting the electrical wiring of the Hall effect sensor or else by programming the evaluation electronics, to given requests and requirements. The permanent magnet, which moves in conjunction with the actuating unit 102, is used as an indicator 106, and a fixedly assembled Hall effect sensor is affected by the change in the magnetic flux in its environment and therefore changes its output signal.

As an alternative to this arrangement, an inductive proximity sensor (eddy-current sensor), which is affected by a displaceable metallic plate, may, of course, also be used as a sensor 108. Finally, systems that operate on a capacitive or optical basis are also conceivable.

If a flexible circuit 122 comprising electrically conductive tracks is used for electrically contacting the sensor 108, this has the advantage of ensuring reliable and robust electrical contacting, while taking up as little space as possible. It is also possible to transfer parts of the electronics for activating the detector unit 120 to this flexible circuit 122, in order to relieve the central processor units of sensor-specific tasks.

If a plug connector 126 is provided for connecting the detector unit 120 to external connections, optimal flexibility and exchangeability of the individual components may be achieved. If repairs have to be undertaken, the load suspension device 100 may be exchanged without having to alter the wiring.

In an advantageous development of the load suspension device 100 according to the invention, the actuating unit 102 is part of a housing in which the assembly unit 112 is at least partially accommodated. The actuating unit 102 may, for example, be formed by a deformable panel, the center of which is deflected under the effect of a load and transmits this deflection, via a contact region, onto the indicator 106.

The advantageous characteristics of the detector unit 120 according to the invention and of the load suspension device 100 are particularly effective if the actuating unit 102 may be connected to a vehicle seat, and the sensor signal is configured in such a way that it activates an airbag system as a function of loading of the vehicle seat. However, other vehicle functions may, of course, also be activated as a function of the occupancy of the seat. Moreover, it will be clear to a person skilled in the art that the detector unit 120 according to the invention and the load suspension device 100 may also be used in other fields, for example weighing technology.

What is claimed is:

1. A contactless detector unit for a load suspension device, comprising:
a sensor for producing a sensor signal in response to a position of an indicator with respect to the sensor, the sensor being assembled in an assembly unit, and the position of the indicator may be changed by an actuating unit in response to a load,
the indicator being arranged on the assembly unit, and the assembly unit having a flexible region, which may be moved for changing the position of the indicator with respect to the sensor.

2. The detector unit according to claim 1, wherein the indicator is held in the assembly unit in such a way that its position with respect to the sensor is adjustable in an unloaded state.

3. The detector unit according to claim 2, wherein the flexible region is formed by a film hinge.

4. The detector unit according to claim 3, wherein the flexible region is formed by at least one resilient web, which is cut free and fixed on two sides.

5. The detector unit according to claim 4, wherein the sensor comprises at least one Hall effect sensor, and the indicator comprises at least one permanent magnet.

6. The detector unit according claim 5, wherein the detector unit comprises a flexible circuit for electrically contacting the sensor.

7. The detector unit according to claim 6, wherein at least one electrical connection is arranged on the assembly unit for electrically contacting the detector unit.

8. The detector unit according to claim 7, wherein the electrical connection is formed by a plug connector.

9. A load suspension device comprising:
a contactless detector unit, having a sensor for producing a sensor signal in response to a position of an indicator with respect to the sensor, the sensor being assembled in an assembly unit, and the position of the indicator may be changed by an actuating unit in response to a load,
the indicator being arranged on the assembly unit, and the assembly unit having a flexible region, which may be moved for changing the position of the indicator with respect to the sensor.

10. The load suspension device according to claim 9, wherein the actuating unit comprises a contact region for moving the indicator, the position of which is adjustable for adjusting the position of the indicator with respect to the sensor in an unloaded state.

11. The load suspension device according to claim 10, wherein the contact region is formed by an adjusting screw.

12. The load suspension device according to claim 11, wherein the flexible region is formed by a film hinge.

13. The load suspension device according to claim 12, wherein the flexible region is formed by at least one resilient web, which is cut free and fixed on two sides.

14. The load suspension device according to claim 13, wherein the sensor comprises at least one Hall effect sensor, and the indicator comprises at least one permanent magnet.

15. The load suspension device according to claim 14, wherein the detector unit comprises a flexible circuit for electrically contacting the sensor.

16. The load suspension device according to claim 15, wherein the actuating unit is part of a housing in which the assembly unit is at least partially accommodated.

17. The load suspension device according to claim 16, wherein a sealed connection region is arranged on the housing for connecting electrical contacts of the detector unit.

18. The load suspension device according to claim 17, wherein the connection region is formed by a plug connector

19. The load suspension device according to claim 18, wherein the actuating unit may be connected to a vehicle seat, and the sensor signal is configured in such a way that it activates an airbag system as a function of loading of the vehicle seat.
